(19) United States
(12) Patent Application Publication
(10) Pub. No.: US 2024/0310566 A1
(43) Pub. Date: Sep. 19, 2024

(54) Waveguide Display with Staircase Grating Input Coupler

(71) Applicant: Apple Inc., Cupertino, CA (US)

(72) Inventors: Choon How Gan, Cheltenham (GB); Adam Backer, Albany, NY (US); Ben-Li Sheu, Sunnyvale, CA (US); Francesco Aieta, Alameda, CA (US); Ping Qu, Cupertino, CA (US); Se Baek Oh, Hillsborough, CA (US); Zhenwen Ding, San Jose, CA (US)

(21) Appl. No.: 18/597,862

(22) Filed: Mar. 6, 2024

Related U.S. Application Data
(60) Provisional application No. 63/490,754, filed on Mar. 16, 2023.

(51) Int. Cl. F21V 8/00; G02B 27/01

(52) U.S. Cl. CPC G02B 6/0016; G02B 6/0018; G02B 6/0036; G02B 27/0172

(57) ABSTRACT

An electronic device may have a waveguide, an input coupler that couples light into the waveguide, and an optical coupler that couples the light out of the waveguide. A medium may be layered onto the waveguide. The input coupler may include a first surface relief grating (SRG) and the optical coupler may include a second SRG in the medium. The first SRG may be a non-binary staircase SRG having ridges with multiple steps. The second SRG may be a binary SRG having troughs that extend to the height of the lowest steps of the first SRG. A reflective layer may fill the first SRG. Forming the input coupler using a staircase SRG may serve to maximize the in-coupling efficiency of the input coupler, thereby maximizing the efficiency with which the light is provided to an eye box.

This application claims the benefit of U.S. Provisional Patent Application No. 63/490,754, filed Mar. 16, 2023, which is hereby incorporated by reference herein in its entirety.

### BACKGROUND

This disclosure relates to electronic devices such as electronic devices having displays with optical systems.

Displays in electronic devices can display images near the eyes of a user. Such electronic devices often include headsets with displays having optical elements that allow users to view the displays. If care is not taken, the optical elements can be undesirably bulky or might not exhibit a desired optical performance.

### SUMMARY

An electronic device may have a display system for providing image light to an eye box. The display system may include a waveguide. An input coupler may couple light into the waveguide. A cross-coupler may perform pupil expansion on the light. An output coupler may couple the light out of the waveguide and towards an eye box. Alternatively, the cross-coupler and the output coupler may be replaced by an interleaved coupler that couples the light out of the waveguide and expands the light.

A medium may be layered onto the waveguide. The input coupler may include a first surface relief grating (SRG) in the medium. The output coupler or the interleaved coupler may include a second SRG in the medium. The first SRG may be a non-binary staircase SRG. The ridges of the first SRG may have a first step that extends from a lower surface of the medium to a first height from the lower surface of the medium. The ridges of the first SRG may have a second step that extends from the first step to a second height from the lower surface of the medium. The second height may be equal to a thickness of the medium. If desired, the ridges of the first SRG may have a third step that extends from the lower surface medium to the first height from the lower surface of the medium at an opposing side of the second step. A reflective layer may fill the first SRG if desired. An encapsulation layer may be disposed over the first and second SRGs if desired.

The second SRG may be a binary SRG having troughs that extend from an upper surface of the medium to a distance from the lower surface of the medium equal to the second height. Forming the input coupler using a staircase SRG may serve to maximize the in-coupling efficiency of the input coupler, thereby maximizing the efficiency with which the image light is provided to the eye box.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIGS. 3A-3C are top views of illustrative waveguides provided with a surface relief grating in accordance with some embodiments.

FIG. 4 is a front view of an illustrative waveguide having optical couplers formed from surface relief gratings in accordance with some embodiments.

FIG. 5 is a front view of an illustrative waveguide having an optical coupler with first and second overlapping surface relief gratings oriented in different directions in accordance with some embodiments.

FIG. 6 is a top view of an illustrative waveguide having a layer of grating medium with an input coupler that includes a staircase surface relief grating and with an output coupler that includes an additional surface relief grating in accordance with some embodiments.

FIGS. 7-9 are exploded top views of a single ridge of an illustrative staircase surface relief grating showing different examples of how the ridge may be covered by a reflective layer and an encapsulation layer in accordance with some embodiments.

FIG. 10 is an exploded top view of a single ridge of an illustrative staircase surface relief grating showing how the ridge may be disposed over an additional layer in accordance with some embodiments.

FIGS. 11 and 12 are exploded top views of a single ridge of an illustrative staircase surface relief grating showing examples of how the ridge may include multiple lower steps on opposing sides of an upper step in accordance with some embodiments.

FIGS. 13-37 are exploded top views of a single ridge of an illustrative staircase relief grating showing different examples of how the ridge may be provided with one or more tilted sidewalls in accordance with some embodiments.

FIG. 38 is showing one example of how a layer of grating medium may be fabricated to include an input coupler having a staircase surface relief grating and an output coupler having an additional surface relief grating in accordance with some embodiments.

### DETAILED DESCRIPTION

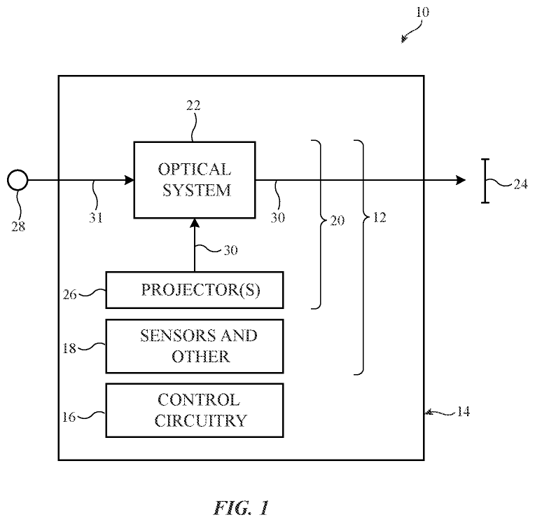

System 10 of FIG. 1 may be a head-mounted device having one or more displays. The displays in system 10 may include near-eye displays 20 mounted within support structure (housing) 14. Support structure 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as support structure 14. Each projector 26 may emit image light 30 that is redirected towards a user's eyes at eye box 24 using an associated one of optical systems 22. Image light 30 may be, for example, light that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner, etc.) to allow real-world light 31 (sometimes referred to herein as world light 31 or ambient light 31) produced and/or reflected from real-world objects 28 (sometimes referred to herein as external objects 28) to be combined optically with virtual (computer-generated) images such as virtual images in image light 30. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of external objects and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

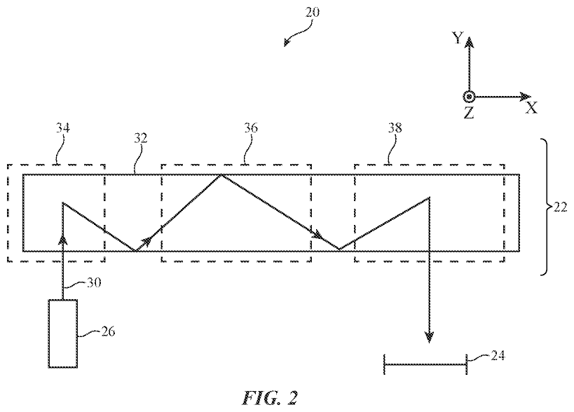

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer), gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is merely illustrative. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38. Implementations in which cross-coupler 36 or a single optical coupler that performs the operations of both cross-coupler 36 and output coupler 38 (e.g., which receives light from an input coupler) include surface relief gratings (SRGs) are described herein as an example.

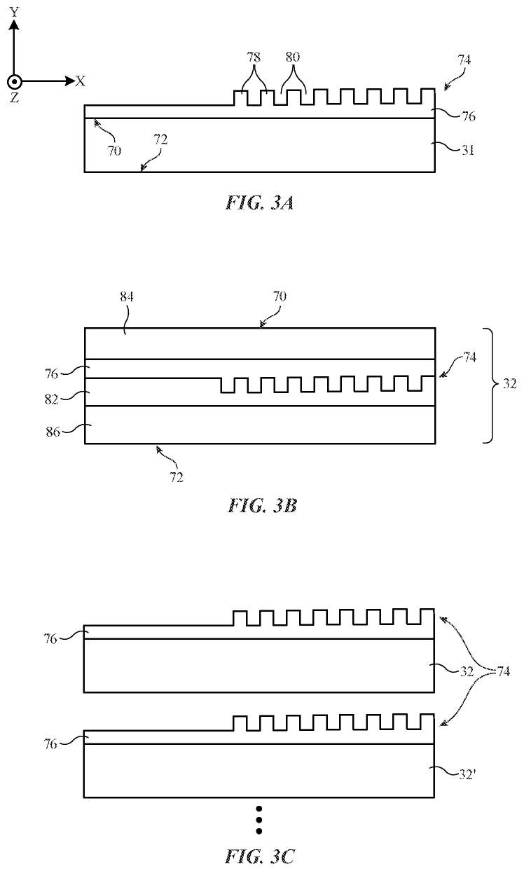

FIG. 3A is a top view showing one example of how a surface relief grating may be formed on waveguide 32. As shown in FIG. 3A, waveguide 32 may have a first lateral surface 70 and a second lateral surface 72 opposite lateral surface 70 (sometimes referred to herein as waveguide surfaces). Waveguide 32 may include any desired number of one or more stacked waveguide substrates. If desired, waveguide 32 may also include a layer of grating medium sandwiched (interposed) between first and second waveguide substrates (e.g., where the first waveguide substrate includes lateral surface 70 and the second waveguide substrate includes lateral surface 72).

Waveguide 32 may be provided with a surface relief grating (SRG) such as surface relief grating 74. SRG 74 may be included in cross-coupler 36 or as part of an optical coupler that performs the operations of both cross-coupler 36 and output coupler 38 (e.g., a diamond expander or interleaved coupler), for example. SRG 74 may be formed within a substrate such as a layer of SRG substrate 76 (sometimes referred to herein as medium 76, medium layer 76, SRG medium 76, or SRG medium layer 76). While only a single SRG 74 is shown in SRG substrate 76 in FIG. 3A for the sake of clarity, SRG substrate 76 may include two or more SRGs 74 (e.g., SRGs having different respective grating vectors). If desired, at least a portion of each of the SRGs may be superimposed in the same volume of SRG substrate 76. In the example of FIG. 3A, SRG substrate 76 is layered onto lateral surface 70 of waveguide 32. This is merely illustrative and, if desired, SRG substrate 76 may be layered onto lateral surface 72 (e.g., the surface of waveguide 32 that faces the eye box).

SRG 74 may include peaks 78 and troughs 80 in the thickness of SRG substrate 76.

Peaks 78 may sometimes also be referred to herein as ridges 78 or maxima 78. Troughs 80 may sometimes also be referred to herein as notches 80, slots 80, grooves 80, or minima 80. In the example of FIG. 3A, SRG 74 is illustrated for the sake of clarity as a binary structure in which SRG 74 is defined either by a first thickness associated with ridges 78 or a second thickness associated with troughs 80. This is merely illustrative. If desired, SRG 74 may be non-binary (e.g., may include any desired number of thicknesses following any desired profile, may include ridges 78 that are angled at non-parallel fringe angles with respect to the Y axis, etc.), may include ridges 78 with surfaces that are tilted (e.g., oriented outside of the X-Z plane), may include troughs 80 that are tilted (e.g., oriented outside of the X-Z plane), may include ridges 78 and/or troughs 80 that have heights and/or depths that follow a modulation envelope, etc. If desired, SRG substrate 76 may be adhered to lateral surface 70 of waveguide 32 using a layer of optically clear adhesive (not shown). SRG 74 may be fabricated separately from waveguide 32 and may be adhered to waveguide 32 after fabrication or may be etched into SRG substrate 76 after SRG substrate 76 has already been layered on waveguide 32, for example.

The example of FIG. 3A is merely illustrative. In another implementation, SRG 74 may be placed at a location within the interior of waveguide 32, as shown in the example of FIG. 3B. As shown in FIG. 3B, waveguide 32 may include a first waveguide substrate 84, a second waveguide substrate 86, and a media layer 82 interposed between waveguide substrate 84 and waveguide substrate 86. Media layer 82 may be a grating or holographic recording medium, a layer of adhesive, a polymer layer, a layer of waveguide substrate, or any other desired layer within waveguide 32. SRG substrate 76 may be layered onto the surface of waveguide substrate 84 that faces waveguide substrate 86. Alternatively, SRG substrate 76 may be layered onto the surface of waveguide substrate 86 that faces waveguide substrate 84.

If desired, multiple SRGs 74 may be distributed across multiple layers of SRG substrate, as shown in the example of FIG. 3C. As shown in FIG. 3C, the optical system may include multiple stacked waveguides such as at least a first waveguide 32 and a second waveguide 32′. A first SRG substrate 76 may be layered onto one of the lateral surfaces of waveguide 32 whereas a second SRG substrate 76′ is layered onto one of the lateral surfaces of waveguide 32′. First SRG substrate 76 may include one or more of the SRGs 74. Second SRG substrate 76′ may include one or more of the SRGs 74. This example is merely illustrative. If desired, the optical system may include more than two stacked waveguides. In examples where the optical system includes more than two waveguides, each waveguide that is provided with an SRG substrate may include one or more SRG 74. While described herein as separate waveguides, waveguides 32 and 32′ of FIG. 3C may also be formed from respective waveguide substrates of the same waveguide, if desired. The arrangements in FIGS. 3A, 3B, and/or 3C may be combined if desired. If desired, waveguide 32 may include a first SRG 74 formed in a first SRG substrate 76 layered onto (e.g., directly contacting) lateral surface 70 of waveguide 32 and may include a second SRG 74 formed in a second SRG substrate 76 layered onto (e.g., directly contacting) lateral surface 72 of waveguide 32.

If desired, waveguide 32 may include one or more substrates having regions that include diffractive gratings for input coupler 34, cross-coupler 36, and/or output coupler 38 and having regions that are free from diffractive gratings. FIG. 4 is a front view showing one example of how waveguide 32 may include one or more substrates having regions that include diffractive gratings for input coupler 34, cross-coupler 36, and/or output coupler 38 and having regions that are free from diffractive gratings.

As shown in FIG. 4, waveguide 32 may include one or more substrates 89 (e.g., a single substrate 89 or multiple stacked substrates 89) on one or more waveguides 32 (e.g., a single waveguide 32 or multiple stacked waveguides 32). Substrate(s) 89 may include one or more layers of grating media such as SRG substrate 76 (FIGS. 3A-3B). One or more diffractive grating structures 88 used to form optical couplers for waveguide 32 may be disposed or formed in substrate(s) 89. Each diffractive grating structure 88 may include one or more SRGs 74 (FIGS. 3A-3C).

For example, substrate(s) 89 may include a first diffractive grating structure 88A (sometimes referred to herein as grating structure 88A or grating(s) 88A) formed from a first set of one or more overlapping SRGs 74 (FIGS. 3A-3C) in a first region of substrate(s) 89. If desired, substrate(s) 89 may also include a second diffractive grating structure 88B (sometimes referred to herein as grating structure 88B or grating(s) 88B) formed from a second set of one or more overlapping SRGs 74 in a second region of substrate(s) 89 that is laterally separated from first diffractive grating structure 88A. If desired, substrate(s) 89 may further include a third diffractive grating structure 88C (sometimes referred to herein as grating structure 88C or grating(s) 88C) formed from a third set of one or more overlapping SRGs 74 in a third region of substrate(s) 89 that is laterally separated from first diffractive grating structure 88A and second diffractive grating structure 88B.

Diffractive grating structures 88A, 88B, and 88C may each form respective optical couplers for waveguide 32. For example, diffractive grating structure 88A may form input coupler 34 for waveguide 32. Diffractive grating structure 88B may form cross-coupler (e.g., pupil expander) 36 on waveguide 32. Diffractive grating structure 88C may form output coupler 38 for waveguide 32. Diffractive grating structure 88A may therefore couple a beam 92 of image light 30 into waveguide 32 and towards diffractive grating structure 88B. Diffractive grating structure 88B may redirect image light 30 towards diffractive grating structure 88C and may optionally perform pupil expansion on image light 30 (e.g., may split image light 30 into multiple paths to form a larger beam that covers the eye pupil and forms a more uniform image). Diffractive grating structure 88C may couple image light 30 out of waveguide 32 and towards the eye box. If desired, diffractive grating structure 88C may also perform pupil expansion on image light 30.

Substrate(s) 89 and thus waveguide 32 may also include one or more regions 90 that are free from diffractive grating structures 88, diffractive gratings, or optical couplers. Regions 90 may, for example, be free from ridges 78 and troughs 80 of any SRGs (FIGS. 3A-3C) and may, if desired, be free from refractive index modulations of VPHs. Regions 90 may separate diffractive grating structure 88A from diffractive grating structure 88B, may separate diffractive grating structure 88B from diffractive grating structure 88C, may separate diffractive grating structure 88C from diffractive grating structure 88A, and/or may laterally surround one or all of diffractive grating structures 88A-C. Regions 90 may sometimes be referred to herein as grating-free regions 90, inter-grating regions 90, non-grating regions 90, or non-diffractive regions 90. Non-diffractive regions 90 may, for example, include all of the lateral area of substrate(s) 89 that does not include a diffractive grating.

Each diffractive grating structure 88 in substrate(s) 89 may span a corresponding lateral area of substrate(s) 89. The lateral area spanned by each diffractive grating structure 88 is defined (bounded) by the lateral edge(s) 94 of that diffractive grating structure 88. Lateral edges 94 may separate or divide the portions of substrate(s) 89 that include thickness modulations used to form one or more SRG(s) in diffractive grating structures 88 from the non-diffractive regions 90 on substrate(s) 89. In other words, lateral edges 94 may define the boundaries between diffractive grating structures 88 and non-diffractive regions 90. Diffractive grating structures 88A, 88B, and 88C may have any desired lateral shapes (e.g., as defined by lateral edges 94).

The example of FIG. 4 is merely illustrative and, in general, input coupler 34, cross-coupler 36, and output coupler 38 may have any desired lateral outlines or shapes (e.g., as defined by lateral edges 94). If desired, waveguide 32 may include an optical coupler that both redirects and expands/replicates image light 30 (e.g., for filling as large of an eye box 24 with as uniform-intensity image light 30 as possible). Such an optical coupler, which is sometimes referred to herein as a diamond expander or interleaved coupler, may perform the functionality of both cross coupler 36 and output coupler 38. By using the optical coupler as both a cross-coupler and an output coupler, space may be conserved within the display (e.g., space that would otherwise be occupied by separate cross-coupler and output couplers).

FIG. 5 is a front view of one such optical coupler 109 on waveguide 32. Optical coupler 109 may, for example, replace cross coupler 36 and output coupler 38 on waveguide 32 of FIG. 4. As shown in FIG. 5, optical coupler 109 may include a diffractive grating structure 88D having at least a first SRG 74A and a second SRG 74B on substrate(s) 89. SRGs 74A and 74B may be superimposed with each other in the same SRG substrate (e.g., substrate 89 or SRG substrate 76 of FIGS. 3A-3C). As another example, SRG 74A may be disposed in a first SRG substrate (e.g., a first substrate 89 or SRG substrate 76 of FIGS. 3A-3C) layered onto a first side of waveguide 32 (e.g., lateral surface 70 of FIG. 3A) and SRG 74B may be disposed in a second SRG substrate (e.g., a second substrate 89 or SRG substrate 76 of FIGS. 3A-3C) layered onto an opposing second side of waveguide 32 (e.g., lateral surface 72 of FIG. 3A), where SRGs 74A and 74B overlap each other when viewed along the Y-axis as shown in FIG. 5. Each of SRGs 74A and 74B may include a respective set of ridges 78 and troughs 80 (FIGS. 3A-3C) in substrate 89 and extending in different respective orientations. For example, SRG 74A may be characterized by a first grating vector K1 (e.g., oriented orthogonal to the direction of the peaks, troughs, or lines of constant medium thickness in SRG 74A). Similarly, SRG 74B may be characterized by a second grating vector K2 (e.g., oriented orthogonal to the direction of the peaks, troughs, or lines of constant medium thickness in SRG 74B). Grating vector K2 may be oriented non-parallel with respect to grating vector K1.

The magnitude of grating vector K1 corresponds to the widths and spacings (e.g., the period) of the ridges 78 and troughs 80 (fringes) in SRG 74A, as well as to the wavelengths of light diffracted by the SRG. The magnitude of grating vector K2 corresponds to the widths and spacings (e.g., the period) of the ridges 78 and troughs 80 in SRG 74B, as well as to the wavelengths of light diffracted by the SRG. Surface relief gratings generally have a wide bandwidth. The bandwidth of SRGs 74A and 74B may encompass each of the wavelengths in image light 30, for example (e.g., the entire visible spectrum, a portion of the visible spectrum, portions of the infrared or near-infrared spectrum, some or all of the visible spectrum and a portion of the infrared or near-infrared spectrum, etc.). The magnitude of grating vector K2 may be equal to the magnitude of grating vector K1 or may be different from the magnitude of grating vector K1. While illustrated within the plane of the page of FIG. 5 for the sake of clarity, grating vectors K1 and/or K2 may have non-zero vector components parallel to the Y-axis (e.g., grating vectors K1 and K2 may be tilted into or out of the page).

SRG 74A at least partially overlaps SRG 74B in optical coupler 109 (e.g., at least some of the ridges and troughs of each SRG spatially overlap or are superimposed within the same volume of SRG substrate). If desired, the strength of SRG 74A and/or SRG 74B may be modulated in the vertical direction (e.g., along the Z-axis) and/or in the horizontal direction (e.g., along the X-axis). If desired, one or both of SRGs 74A and 74B may have a magnitude that decreases to zero within peripheral regions 108A and 108B of the field of view, which may help to mitigate the production of rainbow artifacts.

Diffractive grating structure 88A of input coupler 34 may couple image light 30 into waveguide 32, which conveys the image light to optical coupler 89 through waveguide 32 (e.g., via total internal reflection). SRGs 74A and 74B may diffract incident image light 30 in two different directions, thereby replicating pupils of the image light. SRGs 74A and 74B may additionally or alternatively expand pupils of the image light. This creates multiple optical paths for image light 30 within optical coupler 89 and allows as large an eye box as possible to be filled with image light 30 of uniform intensity.

As shown in FIG. 5, diffractive grating structure 88D may span a corresponding lateral area of substrate(s) 89. The lateral area spanned by diffractive grating structure 88D is defined (bounded) by the lateral edge(s) 94 of diffractive grating structure 88D. Lateral edges 94 may separate or divide the portions of substrate(s) 89 that include thickness modulations used to form one or more SRG(s) in diffractive grating structures 88D from the non-diffractive regions 90 on substrate(s) 89. In other words, lateral edges 94 may define the boundaries between diffractive grating structures 88D and non-diffractive regions 90. Diffractive grating structures 88D may have any desired lateral shape (e.g., as defined by lateral edges 94).

In some implementations, the diffractive grating structure 88A used to form input coupler 34 of FIG. 4 or FIG. 5 includes a binary SRG having ridges 78 with a single ridge height and having troughs 80 with a single trough depth. However, in practice, implementing the diffractive grating structure 88A as a binary SRG can undesirably limit the input coupling efficiency of input coupler 34. To boost the input coupling efficiency of input coupler 34 and thus the overall efficiency with which image light 30 is provided to eye box 24, the diffractive grating structure 88A used to form input coupler 34 may include a staircase SRG.

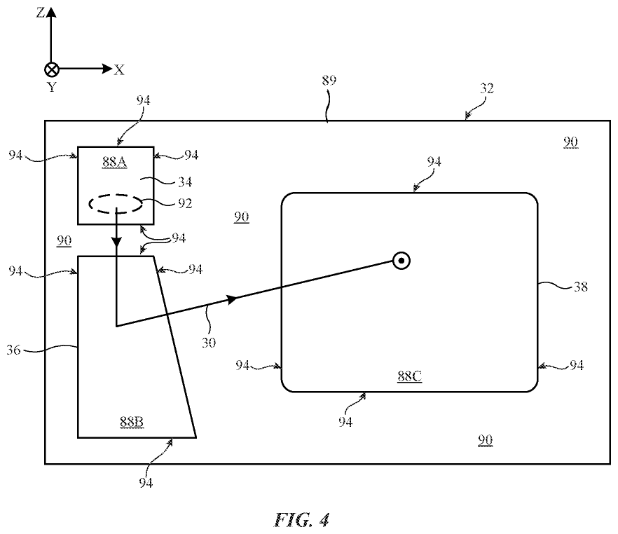

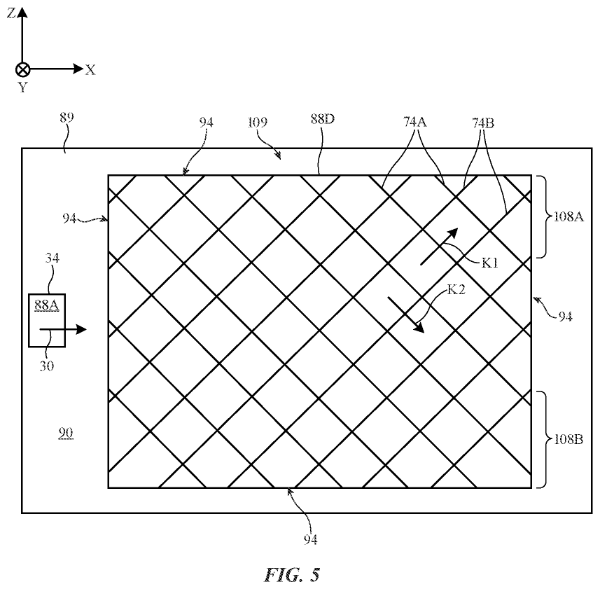

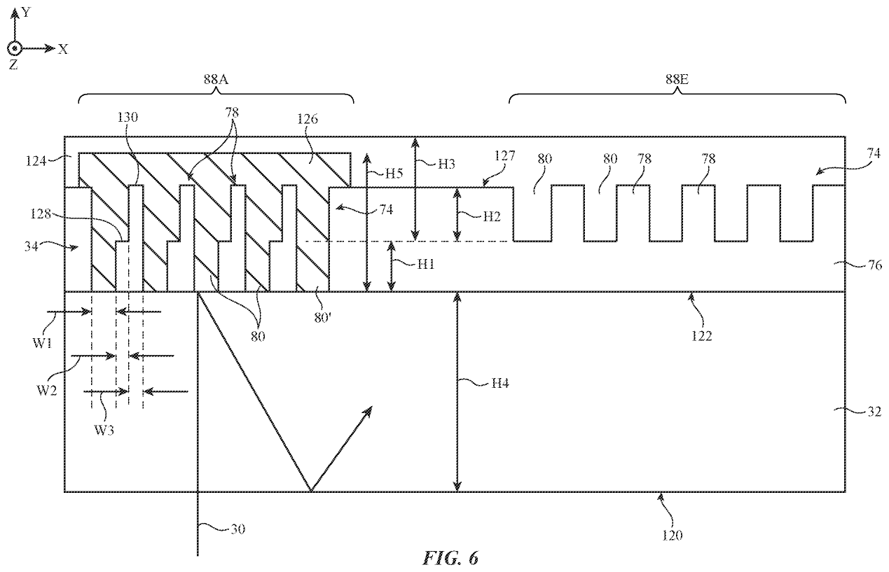

FIG. 6 is a top view showing one example of how the diffractive grating structure 88A used to form input coupler 34 may include a staircase SRG. As shown in FIG. 6, SRG substrate 76 may be layered onto a lateral surface 122 of waveguide 32. Waveguide 32 may have a height (thickness) H4. SRG substrate 76 may have an upper (lateral) surface 127 opposite waveguide 32 and a thickness equal to H1+H2 (e.g., as measured from waveguide 32 to upper surface 127 parallel to the Y-axis). Lateral surface 122 of waveguide 32 may sometimes be referred to herein as waveguide surface 122. Waveguide 32 may also have a lateral (waveguide) surface 120 that opposes waveguide surface 122. Waveguide surface 120 may face eye box 24 whereas waveguide surface 122 faces the environment. This is merely illustrative and, in other implementations, waveguide surface 122 may face eye box 24 whereas waveguide surface 120 faces the environment.

First diffractive grating structure 88A and an additional diffractive grating structure 88E may both be disposed within the same layer of SRG substrate 76. First diffractive grating structure 88A may form input coupler 34 for waveguide 32. First diffractive grating structure 88A may receive image light 30 from the projector through waveguide surface 120, waveguide 32, and waveguide surface 122. First diffractive grating structure 88A may diffract image light 30 at output angles that lie within the TIR range of waveguide 32, which serves to couple image light 30 into waveguide 32. Waveguide 32 may propagate the in-coupled image light 30 via TIR towards additional diffractive grating structure 88E. Image light 30 may be incident upon additional diffractive grating structure 88E from incident angles within the TIR range of waveguide 32. Additional diffractive grating structure 88E may diffract image light 30 onto output angles that are outside of the TIR range of waveguide 32, which serves to couple image light 30 out of waveguide 32 and towards the eye box (e.g., through waveguide surface 122, waveguide 32, and waveguide surface 120).

Additional diffractive grating structure 88E may form optical coupler 109 of FIG. 5 or may form output coupler 38 of FIG. 4. In implementations where additional diffractive grating structure 88E forms optical coupler 109 of FIG. 5, additional diffractive grating structure 88E may form diffractive grating structure 88D of FIG. 5 and may also expand image light 30 upon diffraction. In implementations where additional diffractive grating structure 88E forms output coupler 38 of FIG. 4, additional diffractive grating structure 88E may form diffractive grating structure 88C of FIG. 4 and waveguide 32 may propagate image light 30 towards cross coupler 36 (FIG. 4) prior to passing the image light to the output coupler.

Diffractive grating structure 88A may include an SRG 74 that is implemented as a staircase SRG. Whereas a binary SRG has ridges 78 with a single ridge height and has troughs 80 with a single trough depth, the staircase SRG used to form diffractive grating structure 88A is a type of non-binary SRG having ridges 78 with two ridge heights (or equivalently troughs 80 with two trough depths). The SRG 74 used to form diffractive grating structure 88A may therefore sometimes be referred to herein as staircase SRG 74, staircase grating 74, staircase input coupling grating 74, staircase input coupling SRG 74, non-binary SRG 74, non-binary grating 74, non-binary input coupling grating 74, or non-binary input coupler SRG 74.

As shown in FIG. 6, the ridges 78 of diffractive grating structure 88A (sometimes referred to herein as staircase ridges 78 of the staircase SRG) may each include a first portion 128 and a second portion 130 adjacent to and extending beyond first portion 128. The first portion 128 of ridge 78 may form a first step or stair of ridge 78 that extends to a first height H1 (parallel to the Y-axis) from the underlying substrate (e.g., waveguide surface 122 of waveguide 32). The second portion 130 of ridge 78 may form a second step or stair of ridge 78 that extends to a second height H2 (parallel to the Y-axis) from the upper surface of first portion 128. In other words, the second portion 130 of ridge 78 may extend to a height H1+H2 from the underlying substrate (e.g., waveguide surface 122 of waveguide 32). In this way, first portion 128 may form a lower, first, or bottom step of ridge 78 whereas second portion 130 forms an upper, second, or top step of ridge 78. First portion 128 may therefore sometimes be referred to herein as lower step 128, bottom step 128, or first step 128 of ridge 130 whereas second portion 130 is sometimes referred to herein as upper step 130, top step 130, or second step 130 of ridge 78. The upper (top) surface of upper step 130 may be formed from a portion of the upper surface 127 of waveguide substrate 76.

Equivalently, the troughs 80 of diffractive grating structure 88A (sometimes referred to herein as staircase troughs 78 of the staircase SRG) may each include a first portion that extends from upper surface 127 of waveguide substrate 76 all the way to the lower lateral surface of SRG substrate 76 (e.g., waveguide surface 122). In other words, the first portion of trough 80 may have a depth equal to H1+H2 (e.g., the entire thickness of SRG substrate 76) and may laterally separate the upper step 130 of a given ridge 78 from the lower step 128 of the adjacent ridge 78 in the staircase SRG. The troughs 80 of diffractive grating structure 88A may also each include a second portion that extends from upper surface 127 of waveguide substrate 76 to the upper (top) surface of lower step 128 of ridge 130. In other words, the second portion of trough 80 may have a depth equal to H2 (e.g., may extend through some but not all of SRG substrate 76).

The first portion of trough 80 may have a width W1 (e.g., within the X-Z plane) that separates a given ridge 78 from the adjacent ridge 78 in diffractive grating structure 88A. Lower step 128 of ridge 78 (and the second portion of trough 80) may have a width W1 extending away from upper step 130 (e.g., within the X-Z plane). Upper step 130 of ridge 78 may have a width W3 (e.g., within upper surface 127 of SRG substrate 76 and parallel to the X-Z plane). The upper step 130 of ridge 78 may be laterally separated from the upper step 130 in the adjacent ridge 78 by a distance equal to W1+W2.

Widths W1, W2, and/or W3 may be the same across all the ridges 78 in diffractive grating structure 88A or may vary across the ridges 78 in diffractive grating structure 88A. Similarly, heights H1 and/or H2 may be the same across all the ridges 78 in diffractive grating structure 88A or may vary across the ridges 78 in diffractive grating structure 88A. If desired, some or all of the ridges 78 in diffractive grating structure 88A may include more than two steps with different heights (e.g., three steps, four steps, more than four steps, etc.). If desired, diffractive grating structure 88A may include one or more binary ridges or troughs such as trough 80′.

Diffractive grating structures 88A and 88E may each exhibit a sufficiently large bandwidth to diffract all wavelengths of image light 30 with a sufficiently high diffraction efficiency. For example, diffractive grating structures 88A and 88E may each diffract red, green, and blue wavelengths with a diffraction efficiency exceeding a threshold diffraction efficiency. In this way, input coupler 34 and the optical coupler formed from additional diffractive grating structure 88E may both be formed within the same SRG substrate 76 mounted to the same waveguide surface of the same waveguide 32 without requiring additional waveguides 32 having additional SRG substrates and additional SRGs for diffracting different colors of image light 30. This may serve to minimize the design and manufacturing cost and complexity of the display, may minimize the risk of damage to components of the display, and may minimize the size and weight of the display (e.g., relative to implementations where different waveguides having different SRG layers 76 for coupling different colors of image light 30) thereby making the display as easy and comfortable for the user to wear as possible (e.g., minimizing neck strain, etc.). In addition, by disposing both diffractive grating structures 88A and 88E on the same side of waveguide 32 (e.g., at waveguide surface 122), fabrication cost and complexity and risk of damage to the SRGs during use may be minimized relative to implementations where SRGs are mounted to both waveguide surfaces 122 and 120 of waveguide 32.

In the example of FIG. 6, the staircase SRG is a reflective grating that diffracts image light 30 using one or more reflective diffractive modes (orders). If desired, an additional reflective layer such as reflective layer 126 may be disposed over and within diffractive grating structure 88A. Reflective layer 126 may, for example, fill the troughs 80 of diffractive grating structure 88A and may, if desired, extend to a height H5>(H1+H2) relative to waveguide surface 122. Reflective layer 126 may include metal such as aluminum or silver or may include a dielectric material having a different refractive index than that of SRG substrate 76. Reflective layer 126 may help to boost the amount of image light 30 coupled into waveguide 32 by the staircase SRG (e.g., by helping to reflect any extraneous light that would otherwise pass through the boundaries of SRG substrate 76 back towards and into waveguide 32). Reflective layer 126 may also serve to maximize the mechanical strength, integrity, and resistance to damage of diffractive grating structure 88A.

As shown in FIG. 6, additional diffractive grating structure 88E may include an additional SRG 74 having corresponding troughs 80 and ridges 78 in SRG substrate 76. The SRG in additional diffractive grating structure 88E may be, for example, a binary grating having troughs 80 of a single depth and ridges 78 of a single height. If desired, the ridges 78 in additional diffractive grating structure 88E may extend to the same height as the ridges 78 in diffractive grating structure 88A (e.g., H1+H2). The troughs 80 in additional diffractive grating structure 88E may extend to the same depth as the second portion of the troughs 80 in diffractive grating structure 88A (e.g., to a depth equal to H2 from upper surface 127 of SRG substrate 76). In other words, the troughs 80 in additional diffractive grating structure 88E may extend through the same portion of SRG substrate 76 used to form upper step 130 of the ridges 78 in diffractive grating structure 88A but without extending through the entirety of SRG substrate 76 or beyond lower step 128 of the ridges 78 in diffractive grating structure 88A. This may serve to minimize the fabrication complexity and cost in manufacturing the display system while also maximizing the mechanical strength and integrity of diffractive grating structure 88E, for example.

If desired, an encapsulation layer such as encapsulation layer 124 may be disposed over SRG substrate 76 and reflective layer 126. Encapsulation layer 124 may fill troughs 80 of additional diffractive grating structure 88E without filling the troughs 80 of diffractive grating structure 88A (e.g., due to the presence of reflective layer 126 in the troughs 80 of diffractive grating structure 88A). Encapsulation layer 124 may help to protect one or both of the gratings from damage and/or may help to provide a consistent planar layer over the gratings. Encapsulation layer 124 may be covered with an anti-reflective coating if desired (not shown). Encapsulation layer 124 may extend to a height H3 from the lower surface of the troughs 80 in additional diffractive grating structure 88E, or equivalently to a height H3 from the lower steps 128 of diffractive grating structure 88A or a height H3+H1 from waveguide surface 122.

Implementing diffractive grating structure 88A with a staircase SRG in this way may serve to maximize the optical efficiency with which input coupler 34 couples image light 30 into waveguide 32. The steps of the staircase SRG may, for example, introduce asymmetry to the SRG that increases the intensity of one or more diffraction orders (e.g., the +1R order) and/or that decreases the intensity of one or more other diffraction orders (e.g., the −1R order, the 0R order, etc.) relative to a binary SRG. The geometry of the ridges 78 of the staircase grating may be selected to produce, for example, an increase in the intensity of the diffractive order(s) of the SRG that diffract image light 30 onto output angles within the TIR range of waveguide 32 and/or a decrease in the intensity of the diffractive order(s) of the SRG that diffract image light 30 onto output angles outside the TIR range of waveguide 32.

As one example, height H2 may be 10-100 nm, 20-80 nm, 25 nm, 30-40 nm, 10-50 nm, less than 50 nm, less than 100 nm, greater than 10 nm, greater than 20 nm, greater than 30 nm, or other heights. Height H1 may be 10-100 nm, 1-50 nm, 10-30 nm, 20 nm, 15-25 nm, greater than 10 nm, greater than 15 nm, less than 25 nm, less than 30 nm, less than 50 nm, less than H2, or other heights. Width W1 may be less than width W2, may be greater than width W2, or may be equal to width W2. Width W1+W2+W3 (e.g., the pitch of ridges 78 in diffractive grating structure 88A) may be 400-500 nm, 300-500 nm, 400-420 nm, 410 nm, 412 nm, 350-450 nm, greater than 400 nm, greater than 350 nm, greater than 300 nm, less than 450 nm, or other widths. Height H3 may be 50-100 nm, 70-90 nm, 75-85 nm, 30-120 nm, less than 100 nm, less than 90 nm, less than 120 nm, greater than 70 nm, greater than 50 nm, 80 nm, greater than H2, greater than H1, or other heights. Height H5 may be 100-300 nm, 150-250 nm, 190-210 nm, 200 nm, less than 300 nm, less than 250 nm, greater than 150 nm, greater than 100 nm, greater than height H3, or other heights greater than H1+H2. The height H4 of waveguide 32 may be 0.1-1 mm, 0.5 mm, 0.6 mm, or other heights greater than heights H1, H2, H3, and H5.

This may serve to increase the amount of image light 30 coupled into waveguide 32 by input coupler 34 relative to implementations where the input coupler includes a binary SRG. As examples, the staircase SRG in input coupler 34 may increase the input coupling efficiency (sometimes referred to herein as in-coupling efficiency) of image light 30 by as much as 25-75% across red, blue, and green wavelengths relative to implementations where input coupler 34 includes a binary grating. The staircase SRG may also reduce ghosting produced by input coupler 34 by as much as 10-40% relative to binary gratings. These effects may then result in a cumulative increase in the efficiency of the image light provided to eye box 24 (e.g., the amount of image light emitted by the projector that reaches the eye box) relative to implementations where input coupler 34 includes a binary grating, thereby optimizing the appearance of images at the eye box and minimizing wasted power in the system.

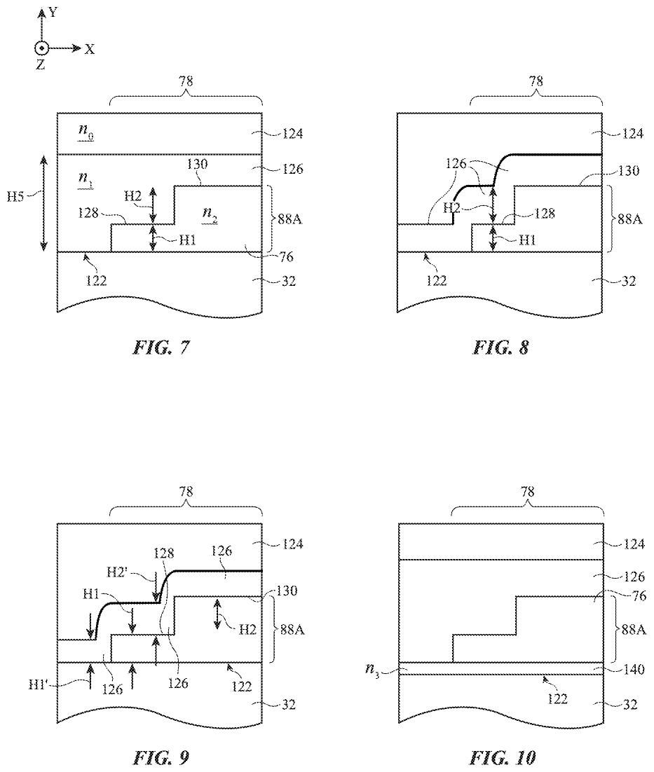

FIG. 7 is an exploded top view of a single ridge 78 of the staircase SRG in diffractive grating structure 88A of input coupler 34. As shown in FIG. 7, SRG substrate 76 and thus ridge 78 may have a refractive index n₂. Reflective layer 126 may be disposed over ridge 78 and may have a refractive index n₁ that is different from refractive index n₂. Encapsulation layer 124 may be disposed over reflective layer 126 and may have a refractive index no that is different from refractive index n₁ and/or refractive index n₂. SRG substrate 76 and ridge 78 may be formed from titanium dioxide (TiO2), silicon dioxide (SiO₂), or other materials, as examples. Reflective layer 126 may, for example, be formed from aluminum, silver, other metals, or a dielectric material (e.g., a polymer or other dielectric where the contrast in refractive index between reflective layer 126 and SRG substrate 76 serves to increase light reflection at the SRG). Encapsulation layer 124 may be formed from any desired material. If desired, encapsulation layer 124 may be omitted and refractive index no may be the refractive index of air. If desired, the difference between refractive indices n₁ and n₂ may be greater than the difference between refractive indices n₂ and n₃.

In the example of FIG. 7, reflective layer 126 has a planar upper surface separated from waveguide surface 122 of waveguide 32 by height H5 (e.g., the planar upper surface is separated from lower step 128 by height H5-H1 and is separated from upper step 130 by height H5-H1-H2). This is merely illustrative. If desired, reflective layer 126 may be coated over ridge 78 such that the upper surface of the reflective layer is separated from waveguide surface 122 by different distances across ridge 78 and the corresponding trough 80, as shown in the example of FIG. 8. As shown in FIG. 8, a portion of reflective layer 126 may be coated over waveguide surface 122 with a thickness equal to height H1 of the lower step 128 of ridge 78. A portion of reflective coating 126 may be coated over lower step 128 with a thickness equal to height H2. A portion of reflective coating 126 may be coated over upper step 130 with a thickness equal to height H2, height H1, or another thickness.

The example of FIG. 8 in which the thickness of reflective coating 126 is equal to the heights of the laterally-adjacent portions of ridge 78 is merely illustrative. FIG. 9 shows an example in which reflective coating 126 has thicknesses that are different from the heights of the laterally-adjacent portions of ridge 78. As shown in FIG. 9, the portion of reflective layer 126 coated onto waveguide surface 122 may have a thickness H1′ that is less than the height H1 of the lower step 128 of ridge 78. In addition, the portion of reflective layer 126 coated onto lower step 128 may have a thickness H2′ that is less than the height H2 of the upper step 130 of ridge 78. In another suitable implementation, thickness H1′ may be greater than height H1 and/or thickness H2′ may be greater than height H2. Thickness H1′ may be equal to thickness H2′ or may be different from thickness H2′.

The examples of FIGS. 7-9 in which ridge 78 (SRG substrate 76) is disposed directly onto or directly contacting waveguide surface 122 is merely illustrative. If desired, one or more additional layers may be disposed between ridge 78 and waveguide surface 122. For example, as shown in FIG. 10, an additional layer 140 may be disposed or layered onto (directly contacting) waveguide surface 122. SRG substrate 76 and thus ridge 78 may be disposed or layered onto (directly contacting) additional layer 140. If desired, more than one additional layer 140 may be interposed between SRG substrate 76 and waveguide 32. Additional layer 140 may have a refractive index n₃ that is different from the refractive index n₂ of SRG substrate 76, the refractive index n₁ of reflective layer 126, the refractive index no of encapsulation layer 124, and/or the refractive index of waveguide 32. Additional layer 140 may be formed from hafnium oxide, TiO2, or other materials, as examples. Additional layer 140 may be disposed under the SRG substrate in any of the examples of FIGS. 7-9 and/or in any of the other examples described herein. The examples of FIGS. 7-10 in which diffractive grating structure 88A has two steps up from waveguide 32 to thickness H1+H2 is illustrative and non-limiting. If desired, diffractive grating structure 88A of FIGS. 7-10 may have three steps up from waveguide 32, four steps up from waveguide 32, more than four steps, etc. The examples of FIGS. 7-10 in which the right edge of diffractive grating structure 88A is vertical (e.g., orthogonal to waveguide surface 122) is illustrative and non-limiting. If desired, the right edge of diffractive grating structure 88A may extend at a non-orthogonal angle from waveguide surface 122 (e.g., at any desired angle between around 45 degrees and 100 degrees relative to waveguide surface 122).

The examples of FIGS. 6-10 in which ridge 78 has only a single lower step 128 is merely illustrative. If desired, ridge 78 may have two lower steps 128 on opposing sides of upper step 130. FIG. 11 shows one example in which ridge 78 has two lower steps on opposing sides of upper step 130. As shown in FIG. 11, ridge 78 may include a first lower step 128A at a first side of upper step 130. Ridge 78 may also include a second lower step 128B at a second side of upper step 130 opposite the first side of upper step 130. First lower step 128A and second lower step 128B may both have height H1. Alternatively, the height of second lower step 128B may be different from the height of first lower step 128A. First lower step 128A may have a width W2A. Second lower step 128B may have a width W2B. Width W2B may be the same as width W2A or may be different from width W2A.

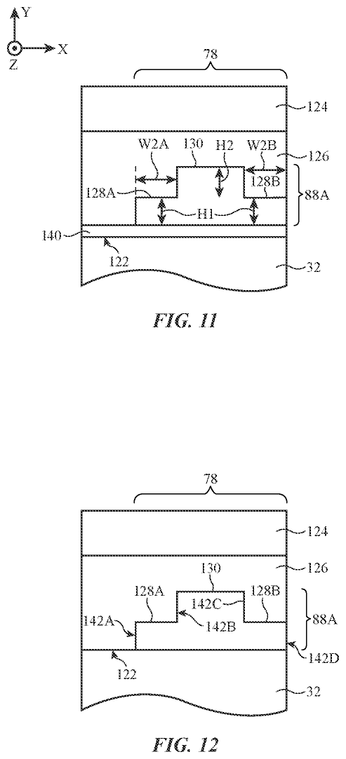

The example of FIG. 11 in which ridge 78 is disposed on additional layer 140 is merely illustrative. If desired, additional layer 140 may be omitted, as shown in FIG. 12. In the examples of FIGS. 10-12, reflective coating 126 covers ridge 78 and/or additional layer 140 with the same thickness configuration as in FIG. 7. Alternatively, if desired, reflective coating 126 may coat additional substrate 140 and/or ridge 78 with the thickness configurations of FIG. 8 or FIG. 9. Encapsulation layer 124 of FIGS. 7-12 may be omitted if desired. Ridge 78 may be provided with any desired combination of the arrangements of FIGS. 6-12.

As shown in FIG. 12, first lower step 128A may have a sidewall 142A extending orthogonally from waveguide surface 122 (or an underlying additional layer 140) to the upper surface of first lower step 128A. Upper step 130 may have opposing sidewalls 142B and 142C. Sidewall 142B may extend orthogonally from the upper surface of first lower step 128A to the upper surface of upper step 130. Sidewall 142C may extend orthogonally from the upper surface of second lower step 128B to the upper surface of upper step 130. Second lower step 128B may have a sidewall 142 extending orthogonally from waveguide surface 122 (or an underlying additional layer 140) to the upper surface of second lower step 128B. In implementations where ridge 78 only includes a single lower step 128, sidewall 142C of upper step 130 may extend from the upper surface of upper step 130 to waveguide surface 122 (or an underlying additional layer 140) and the lower step 128 of ridge 78 has sidewall 142A.

In the examples of FIGS. 7-12, each of the sidewalls 142A-D extend parallel to each other and orthogonal to waveguide surface 122 and the upper surfaces of upper step 130 and lower steps 128, 128A, and 128B extend parallel to waveguide surface 122 and orthogonal to sidewalls 142A-D. This is merely illustrative. If desired, one or more of the upper surfaces of upper step 130 and lower steps 128, 128A, and 128B may be tilted (blazed) at non-parallel angles with respect to each other and/or waveguide surface 122. If desired, one or more of sidewalls 142A-D may be tilted (blazed) at a non-orthogonal angle with respect to waveguide surface 122.

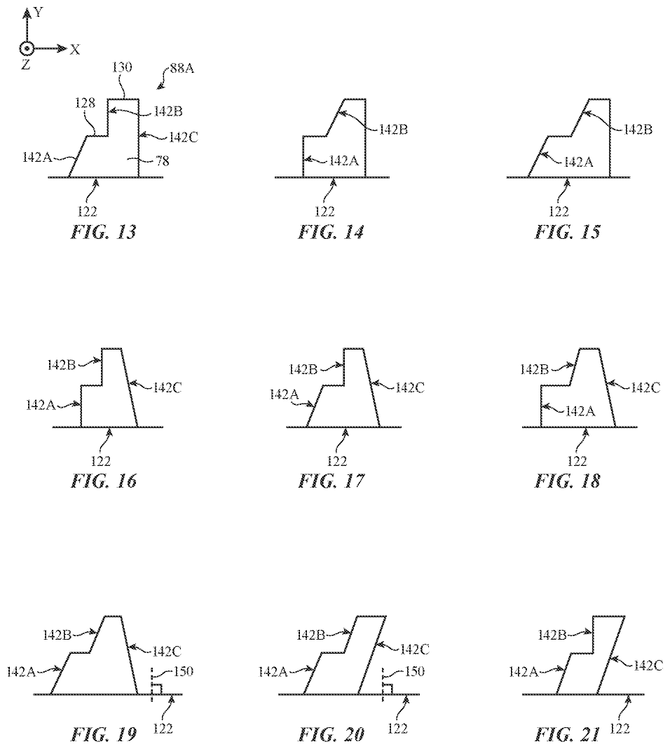

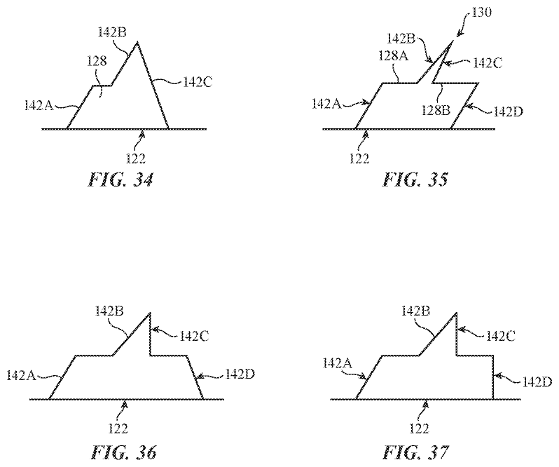

FIGS. 13-37 show non-limiting examples of how the sidewalls and/or upper surfaces of ridge 78 may be tilted in different directions. For example, as shown in FIG. 13, sidewall 142A of lower step 128 may be tilted at a non-orthogonal angle with respect to waveguide surface 122 whereas sidewalls 142B and 142C of upper step 130 extend orthogonal to waveguide surface 122. Alternatively, sidewall 142B (FIG. 14) or both sidewalls 142A and 142B (FIG. 15) may be tilted at a non-orthogonal angle with respect to waveguide surface 122. Sidewalls 142A and 142B may be tilted at the same angle (e.g., may extend parallel to each other) or may be tilted at different angles (e.g., may be non-parallel to each other).

The examples of FIGS. 13-15 in which sidewall 14C extends orthogonal to waveguide surface 122 are merely illustrative. If desired, sidewall 142C may be tilted at a non-orthogonal angle with respect to waveguide surface 122, as shown in FIG. 16. If desired, both sidewall 142A and sidewall 142C may be tilted (FIG. 17), both sidewall 142B and sidewall 142C may be tilted (FIG. 18), or each of sidewalls 142A, 142B, and 142C may be tilted (FIG. 19). Sidewalls 142A and 142B of FIG. 19 may be tilted at the same angle (e.g., may extend parallel to each other) or may be tilted at different angles (e.g., may be non-parallel to each other).

In the examples of FIGS. 17-19, sidewall 142C is tilted at an angle oriented at a first side of the normal axis 150 of waveguide surface 122 (e.g., at an angle greater than 90 degrees with respect to waveguide surface 122) whereas sidewalls 142A and/or 142B are tilted at an angle oriented at a second side of normal axis 150 (e.g., at an angle less than 90 degrees with respect to waveguide surface 122). This is merely illustrative.

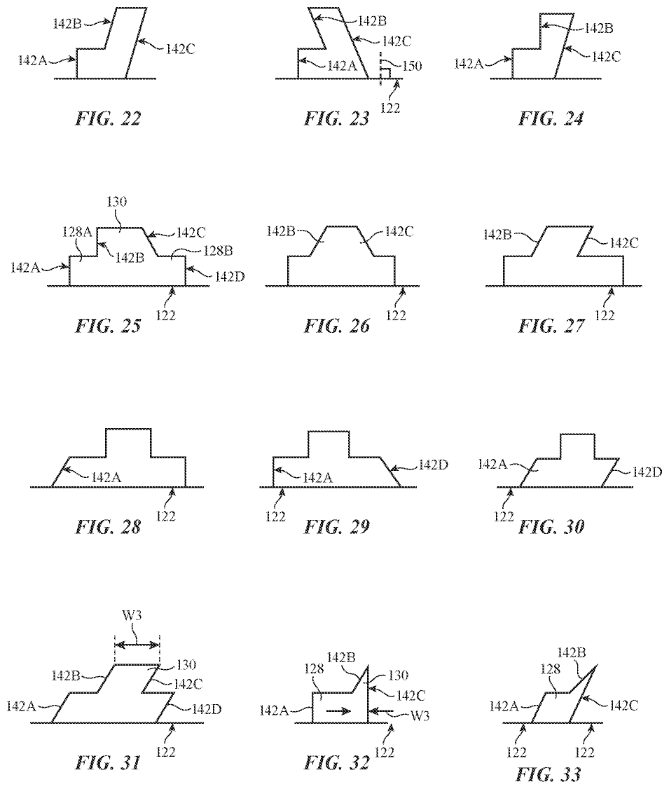

If desired, sidewall 142C may be tilted at an angle that lies on the same side of normal axis 150 as the angle(s) at which sidewalls 142A and/or 142B are tilted. For example, as shown in FIG. 20, sidewalls 142A-C may each be tilted at angles that lie on the same side of normal axis 150. Sidewalls 142A, 142B, and 142C of FIG. 20 may all be tilted at the same angle (e.g., may extend parallel to each other) or may be tilted at different angles (e.g., may be non-parallel to each other). If desired, sidewall 142B may extend orthogonal to waveguide surface 122 (FIG. 21) or sidewall 142A may extend orthogonal to waveguide surface 122 (FIG. 22).

If desired, sidewalls 142B and 142C may extend at angles oriented to the same side of normal axis 150 of waveguide surface 122 whereas sidewall 142A extends orthogonal to waveguide surface 122 (FIG. 23). If desired, the angle with which sidewall 142C of FIG. 16 extends with respect to waveguide surface 122 may be reversed about normal axis 150, as shown in FIG. 24.

In the examples of FIGS. 13-24, ridge 78 only includes a single lower step 128. If desired, ridge 78 may include a first lower step 128A and a second lower step 128B on opposing sides of upper step 130 (e.g., as shown in FIGS. 11 and 12). In these examples, sidewall 142C of upper step 130 may be tilted at a non-orthogonal angle with respect waveguide surface 122 (as shown in FIG. 25), both sidewalls 142B and 142C may be tilted at non-orthogonal angles at different sides of the normal axis of waveguide surface 122 (as shown in FIG. 27), both sidewalls 142B and 142C may be tilted at non-orthogonal angles at the same side of the normal axis of waveguide surface 122 (as shown in FIG. 27), sidewall 142A of first lower step 142A may be tilted at a non-orthogonal angle with respect to waveguide surface 122 (as shown in FIG. 28), both sidewall 142A of first lower step 128A and sidewall 142C of second lower step 128B may be tilted at non-orthogonal angles at opposing sides of the normal axis of waveguide surface 122 (as shown in FIG. 29), both sidewall 142A of first lower step 128A and sidewall 142C of second lower step 128B may be tilted at non-orthogonal angles at the same side of the normal axis of waveguide surface 122 (as shown in FIG. 30), all of sidewalls 142A, 142B, 142C, and 142D may be tilted at non-orthogonal angles at the same side of the normal axis (as shown in FIG. 31), etc.

In general, ridge 78 may be provided with any desired combination of sidewalls 142A, 142B, 142C, and optionally 142D that are tilted at one or more orthogonal and/or non-orthogonal angles at one or both sides of the normal axis of waveguide surface 122 (e.g., any of the arrangements of FIGS. 13-31 may be combined). In the examples of FIGS. 13-31, the upper surface of upper step 130 has width W3. This is merely illustrative. If desired, the upper surface of upper step 130 may have a width that is less than width W3 (e.g., a width of zero) whereas the base of upper step 130 has width W3. For example, as shown in FIG. 32, upper step 130 may have a tilted sidewall 142B that extends from lower step 128 to sidewall 142C of upper step 130. If desired, sidewall 142C may also be tilted (e.g., to the same side of the normal axis as sidewall 142B), as shown in FIG. 33. Sidewall 142A may extend orthogonal to waveguide surface 122 (FIG. 32), at a non-orthogonal angle to the same side of the normal axis as sidewalls 142B and 142C (FIG. 33), or at a non-orthogonal angle on the opposite side of the normal axis from sidewalls 142B and 142C (not shown).

If desired, sidewall 142C of FIG. 33 may be tilted at a non-orthogonal angle from waveguide surface 122 that is oriented on the opposite side of the normal axis of waveguide surface 122 from the tilt angles of sidewalls 142A and 142B, as shown in FIG. 4. In the examples of FIGS. 32-34, ridge 78 only has a single lower step 128. If desired, ridge 78 may have both lower steps 128A and 128B, an upper step 130 having an upper surface with a width of zero, and sidewalls 142A-D that are tilted at non-orthogonal angles with respect to waveguide surface 122 and lying at the same side of the normal axis, as shown in FIG. 35. One or more of the sidewalls may be orthogonal to waveguide surface 122, such as sidewalls 142C of FIGS. 36 and 37 and sidewall 142D of FIG. 37, and/or may be tilted at angles on the opposing side of the normal axis, such as sidewall 142D of FIG. 36. These examples are merely illustrative and non-limiting. The upper surface of upper step 130 in any of the examples of FIGS. 13-37 may have a width of zero, any of the arrangements of FIGS. 13-37 may be combined, any of sidewalls 142A-D may be tilted at any desired angles, and/or ridges 78 may be provided with other geometries. The SRG configurations shown in FIGS. 13-37 may be used to form any desired optical coupling and/or expanding structures on waveguide 32. For example, the diffractive grating structure 88A, the reflective layer 126, and/or the encapsulation layer 124 shown in one or more of FIGS. 13-37 may instead be used to form additional diffractive grating structure 88E of FIG. 6 (e.g., an output coupler), optical coupler 109 of FIG. 5 (e.g., a diamond coupler or expander), diffractive grating structure 88C of FIG. 4 (e.g., an output coupler), diffractive grating structure 88B of FIG. 4 (e.g., a cross-coupler), diffractive grating structure 88A of FIG. 4 (e.g., an input coupler), input coupler 34 of FIG. 2, cross-coupler 36 of FIG. 2, and/or output coupler 38 of FIG. 2.

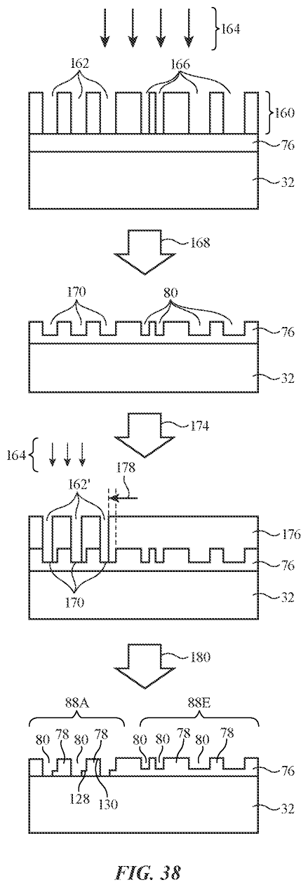

FIG. 38 is a diagram showing one example of how diffractive grating structure 88A and additional diffractive grating structure 88E may be fabricated in SRG substrate 76 using manufacturing equipment. As shown in FIG. 38, manufacturing equipment may dispose SRG substrate 76 onto waveguide 32 and may dispose a photoresist layer 160 onto SRG substrate 76. Photoresist layer 160 may have openings 162 used to form the troughs of diffractive grating structure 88A and openings 166 to form the troughs of additional diffractive grating structure 88E.

The manufacturing equipment may include etching elements 164 (e.g., laser light or other optical emitters, lithographic equipment, etc.) that pass through openings 162 in photoresist layer 160 to form intermediate troughs 170 in SRG layer 76 and that pass through openings 166 in photoresist layer 160 to form troughs 80 of additional diffractive grating structure 88E. Photoresist layer 160 may then be removed, as shown by arrow 168. An additional photoresist layer 176 may then be layered over SRG substrate 76, as shown by arrow 174. Additional photoresist layer 176 may include openings 162′ that overlap intermediate troughs 170 in SRG layer 76 but that are laterally offset from the openings 162 in photoresist layer 160 by offset 178. As such, additional photoresist layer 176 will fill some but not all of intermediate troughs 170.

Etching elements 164 may then pass through openings 162′ in additional photoresist layer 176 to etch through SRG substrate 76 down to waveguide 32 (or an etch stop layer that is not shown for the sake of clarity) within the portion of intermediate troughs 170 not covered by additional photoresist layer 176. Additional photoresist layer 176 may then be removed, as shown by arrow 180, leaving a diffractive grating structure 88A having a staircase SRG (e.g., where the upper and lower steps of the staircase SRG were covered by additional photoresist layer 176) and additional diffractive grating structure 88E having binary ridges 78 and troughs 80. In this way, the same fabrication process may be used to form both diffractive grating structures in the same layer of SRG substrate (e.g., where the troughs 80 of additional diffractive grating structure 88E have the same depth as the portion of the troughs 80 in diffractive grating structure 88A overlapping the lower steps 128 in diffractive grating structure 88A). Such a fabrication scheme may produce an input coupler that exhibits a relatively high in-coupling efficiency that is relatively immune to process tolerance in the horizontal and/or vertical direction during etching. The example of FIG. 38 is merely illustrative and, in general, other fabrication schemes may be used.

The foregoing is merely illustrative and various modifications can be made to the described embodiments. The foregoing embodiments may be implemented individually or in any combination.

What is claimed is:

1. An electronic device comprising:
a waveguide;
a substrate on the waveguide;
a first optical coupler having a first surface relief grating (SRG) in the substrate that is configured to couple light into the waveguide, the first SRG having first ridges with a first step extending to a first height from the waveguide and with a second step extending from the first step to a second height from the waveguide that is greater than the first height; and
a second optical coupler having a second SRG in the substrate that is configured to couple the light out of the waveguide, the second SRG being a binary SRG having second ridges extending to the second height from the waveguide.

2. The electronic device of claim 1, wherein the substrate has a first lateral surface facing the waveguide and a second lateral surface opposite the first lateral surface, the first SRG has first troughs extending from the second lateral surface towards the waveguide between the first ridges, and the second SRG has second troughs that extend from the second lateral surface towards the waveguide between the second ridges.

3. The electronic device of claim 2, wherein the second troughs extend to a distance from the waveguide equal to the first height.

4. The electronic device of claim 2, further comprising:
a reflective layer disposed over the first SRG and filling the first troughs.

5. The electronic device of claim 4, wherein the reflective layer comprises aluminum or silver.

6. The electronic device of claim 4, wherein the reflective layer comprises a dielectric material having a different refractive index than the substrate.

7. The electronic device of claim 4, further comprising:
an encapsulation layer that covers the substrate and the reflective layer and that fills the second troughs.

8. The electronic device of claim 1, wherein the light comprises red, green, and blue wavelengths, the first SRG and the second SRG being configured to diffract the red, green, and blue wavelengths of the light.

9. The electronic device of claim 1, further comprising:
a reflective coating overlapping the first SRG, wherein the reflective coating has a first portion overlapping the waveguide, a second portion overlapping the first step of the first ridges, and a third portion overlapping the second step of the first ridges.

10. The electronic device of claim 9, wherein the first portion of the reflective coating has a first thickness equal to the first height and the second portion of the reflective coating has a second thickness equal to the second height.

11. The electronic device of claim 9, wherein the first portion of the reflective coating has a first thickness less than the first height and the second portion of the reflective coating has a second thickness less than the second height.

12. The electronic device of claim 1, further comprising:
a dielectric layer interposed between the waveguide and the substrate.

13. The electronic device of claim 1, wherein the first step of the first ridges is located at a first side of the second step of the first ridges and wherein the first ridges have a third step at a second side of the second step, the third ridges extending to a third height from the waveguide that is equal to the first height.

14. The electronic device of claim 1, wherein a sidewall of the first step or the second step is tilted at a non-orthogonal angle with respect to a lateral surface of the waveguide.

15. The electronic device of claim 1, further comprising:
a third optical coupler having a third SRG in the substrate, the third optical coupler being configured to redirect the light from the first optical coupler towards the second optical coupler.

16. The electronic device of claim 1, wherein the second optical coupler is configured to expand a pupil of the light upon diffracting the light.

17. An electronic device comprising:
a waveguide;
a medium layered on the waveguide, the medium having a first lateral surface facing the waveguide and a second lateral surface opposite the first lateral surface;
an input coupler having a non-binary surface relief grating (SRG) with first troughs extending from the second lateral surface towards the waveguide, wherein the input coupler is configured to couple light into the waveguide, the first troughs have first portions extending through all of a thickness of the medium, and the first troughs have second portions extending through some but not all of the thickness of the medium; and
an optical coupler having a binary SRG with second troughs extending from the second lateral surface towards the waveguide through some but not all of the thickness of the medium, the optical coupler being configured to couple the light out of the waveguide.

18. The electronic device of claim 17, further comprising:
an encapsulation layer disposed over the second lateral surface of the medium, wherein the encapsulation layer fills the second troughs but not the first troughs.

19. The electronic device of claim 17, wherein the first portions of the first troughs have a first depth, the second portions of the first troughs have a second depth less than the first depth, and the second troughs have a third depth equal to the second depth.

20. An electronic device comprising:
a waveguide;
a substrate on the waveguide, the substrate having a first lateral surface facing the waveguide and a second lateral surface opposite the first lateral surface;
an input coupler having a surface relief grating (SRG) in the medium and configured to couple light into the waveguide, the first SRG having a set of ridges extending from the first lateral surface towards the second lateral surface of the medium, and each ridge in the set of ridges comprising
a first step that extends from the first lateral surface to the second lateral surface,
a second step that extends from the first lateral surface to a height from the first lateral surface, the second step being shorter than the first step, and
a third step that extends from the first lateral surface to the height from the first lateral surface, wherein the third step is shorter than the first step and the second step is interposed between the first step and the third step; and
an optical coupler having a binary SRG configured to couple the light out of the waveguide, the binary SRG having troughs that extend from the second lateral surface to a distance from the first lateral surface equal to the height of the first and third steps.
